(19) United States
(12) Patent Application Publication
(10) Pub. No.: US 2011/0178690 A1
(43) Pub. Date: Jul. 21, 2011

(54) VARIATION ESTIMATING DEVICE OF OBJECT

(75) Inventors: Mitsumasa Fukumura, Susono-shi (JP); Junya Mizuno, Numazu-shi (JP)

(73) Assignee: TOYOTA JIDOSHA KABUSHIKI KAISHA, Toyota-shi, Aichi-ken (JP)

(21) Appl. No.: 13/055,629

(22) PCT Filed: May 21, 2009
(86) PCT No.: PCT/JP2009/059350

§ 371 Date: Jan. 24, 2011

(51) Int. Cl. F02D 28/00

(52) U.S. Cl. 701/101; 180/65.21; 903/902

(57) ABSTRACT

The variation estimating device of object is preferably used for estimating the variation of the object with respect to the time axis. The first estimating unit estimates the variation of the object behind the actual variation of the object, and the second estimating unit estimates the variation of the object before the actual variation of the object. Then, the correcting unit performs the correction of one of the first estimating unit and the second estimating unit based on the other, so as to calculate the variation of the object, when the object varies. Therefore, it becomes possible to improve the estimation accuracy of the variation of the object.

### TECHNICAL FIELD

The present invention relates to a technical field of estimating a variation of an object with respect to a time axis.

### BACKGROUND TECHNIQUE

Conventionally, there has been proposed a technique of estimating variation of an object, such as an engine torque. For example, Patent Reference 1 proposes an estimating method of driving force (engine torque) by using a disturbance observer. Specifically, this technique proposes estimating a driving force by the disturbance observer in a first or a second mode and performing a motor torque control by a feed forward acceleration control in a mode transition period, in a hybrid vehicle which travels by transferring power to the tires via a transmission having a function of switching between the first mode and the second mode of different characters by connecting and releasing friction elements.

Other than this Patent Reference 2 proposes a method of estimating an engine torque by using an intake air amount of the engine as a reference.

### PRIOR ART REFERENCE

### Patent Reference

Patent Reference 1: Japanese Patent Application Laid-open under No. 2006-34076

Patent Reference 2: Japanese Patent Application Laid-open under No. 2002-201998

### DISCLOSURE OF INVENTION

### Problem to be Solved by the Invention

However, in the technique described in the above-mentioned Patent Reference 1, there is a case that the engine torque cannot be accurately estimated at the mode transition period and the like. For example, the estimation method based on the disturbance observer performs differentiation in the operation process, and hence it is practically necessary to use a filter to eliminate the noise caused by the differentiation. Therefore, the method calculates the value having a delay with respect to the actual variation of the engine torque.

On the other hand, in the technique described in Patent Reference 2, there is a case that the engine torque cannot be accurately estimated by the influence of the friction variation and/or the combustion state variation depending upon the temperature of the engine and/or the cooling water, for example.

The present invention is made to solve the problem described above, and it is an object of the invention to provide a variation estimating device of object, capable of accurately estimating the variation of the object, such as the engine torque.

### Means for Solving the Problem

According to one aspect of the present invention, there is provided a variation estimating device of object which estimates a variation of an object with respect to a time axis, including: a first estimating unit which estimates a variation of the object behind an actual variation of the object; a second estimating unit which estimates a variation of the object before the actual variation of the object; and a correcting unit which performs a correction of one of the first estimating unit and the second estimating unit based on the other, so as to calculate a variation of the object, when the object varies.

The above variation estimating device of object is preferably used for estimating the variation of the object with respect to the time axis. The first estimating unit estimates the variation of the object behind the actual variation of the object. For example, the first estimating unit detects or obtains a value related to the actual variation of the object, and calculates the variation of the object based on the value. The second estimating unit estimates the variation of the object before the actual variation of the object. Then, the correcting unit performs the correction of one of the first estimating unit and the second estimating unit based on the other, so as to calculate the variation of the object, when the object varies. Therefore, it becomes possible to improve the estimation accuracy of the variation of the object. It is prescribed that “estimation” according to the first estimating unit is a concept in which “acquisition” and/or “detection” of the variation of the object can be included.

In a manner of the above variation estimating device of object, the correcting unit can calculate a variation amount of the object indicating the variation with a delay time of the estimation by the first estimating unit with respect to the actual variation of the object, by using the second estimating unit, and the correcting unit can add the calculated variation amount to the variation of the object estimated by the first estimating unit, or subtract the calculated variation amount from the variation of the object estimated by the first estimating unit, so as to perform the correction.

In addition, when the variation of the object estimated by the first estimating unit becomes larger than a predetermined value, the correcting unit can perform the correction.

In another manner of the above variation estimating device of object, the correcting unit changes the predetermined value in accordance with a gradient of the variation of the object estimated by the second estimating unit. Therefore, it is possible to further improve the estimation accuracy of the variation of the object.

In another manner of the above variation estimating device of object, in order to change a delay time of the estimation by the first estimating unit with respect to the actual variation of the object, the first estimating unit changes a control value for adjusting the delay time, in accordance with a gradient of the variation of the object estimated by the second estimating unit. Therefore, it is possible to further improve the estimation accuracy of the variation of the object.

In another manner, the above variation estimating device of object may further include a control unit. In case of changing the control value for adjusting the delay time, the first estimating unit sets a lower limit guard value used for the control value, and the control unit performs a control for restricting the variation of the object so that the control value complies with the lower limit guard value. Therefore, it is possible to appropriately restrict the variation of the object in which the estimation accuracy cannot be ensured.

In another manner of the above variation estimating device of object, the correcting unit learns a delay time of the estimation by the first estimating unit with respect to the estimation by the second estimating unit, and performs the correction based on the learned delay time. Therefore, it is possible to estimate the early behavior of the variation of the object with high accuracy.

Preferably, when the variation of the object estimated by the first estimating unit is equal to or smaller than a predetermined value, the correcting unit can perform the correction based on the learned delay time.

In another manner of the above variation estimating device of object, the correcting unit corrects the variation of the object estimated by the second estimating unit in accordance with a variation of a state value related to the variation of the object, and performs the correction of the first estimating unit based on the corrected variation of the object. Therefore, it is possible to effectively improve the estimation accuracy of the variation of the object.

In a preferred example of the above variation estimating device of object, the first estimating unit estimates a variation of an engine torque as the variation of the object, based on a disturbance observer, and the second estimating unit estimates a variation of the engine torque as the variation of the object, based on an intake air amount of the engine.

In a preferred example of the above variation estimating device of object, the variation estimating device of object is applied to a hybrid vehicle which switches a speed change mode between an infinite variable speed mode and a fixed gear ratio mode by switching between an engagement and a release of engaging components, and the correcting unit performs the correction, when the speed change mode is switched. Therefore, it is possible to improve the quality of the speed change in the hybrid vehicle and improve the responsiveness of the control of the discharge and charge of the battery.

Preferably, the correcting unit continues to perform the correction until the engagement of the engaging components is completed. Therefore, it is possible to improve the engagement performance of the engaging components, and it becomes possible to effectively prevent the delay of the speed change time and the speed change shock.

### EFFECT OF THE INVENTION

The variation estimating device of object according to the present invention is preferably used for estimating the variation of the object with respect to the time axis. The first estimating unit estimates the variation of the object behind the actual variation of the object, and the second estimating unit estimates the variation of the object before the actual variation of the object. Then, the correcting unit performs the correction of one of the first estimating unit and the second estimating unit based on the other, so as to calculate the variation of the object, when the object varies. Therefore, it becomes possible to improve the estimation accuracy of the variation of the object.

### BRIEF DESCRIPTION OF THE DRAWINGS

FIG. 1 shows a schematic configuration of a hybrid vehicle according to an embodiment.

FIG. 2 shows a configuration of a motor generator and a power transmission mechanism.

FIG. 3 shows an alignment chart in a fixed gear ratio mode of a power distribution mechanism.

FIG. 4 shows an example of a relationship between a speed change control and a speed change shock in a hybrid vehicle.

FIG. 5 shows an example of an engine torque estimated by first and second estimating methods.

FIG. 6 shows a diagram for explaining an engine torque estimating method according to a first embodiment.

FIG. 7 is a flow chart showing an engine torque estimating process according to a first embodiment.

FIG. 8 shows a diagram for explaining a problem in such a case that a second predetermined value is relatively small and a filter time constant of a disturbance observer is large.

FIGS. 9A and 9B show diagrams for explaining a method for determining a second predetermined value and a filter time constant of a disturbance observer in a second embodiment.

FIG. 10 shows a diagram for explaining an effect of an engine torque estimating method according to a second embodiment.

FIG. 11 shows a diagram for explaining a problem in such a case that a torque variation is large and a gradient of a torque variation is large.

FIGS. 12A to 12C show diagrams for concretely explaining a method for restricting a variation gradient of an engine torque, in the third embodiment.

FIG. 13 shows a diagram for explaining an effect of an engine torque estimating method according to a third embodiment.

FIG. 14 shows a diagram for explaining a problem which occurs in such a case that a correction of a detected torque is not continued until an engagement of a dog unit is completed.

FIG. 15 shows a diagram for explaining an effect of an engine torque estimating method according to a fourth embodiment.

FIG. 16 is a flow chart showing an engine torque estimating process according to a fourth embodiment.

FIG. 17 shows a diagram for concretely explaining an engine torque estimating method according to a fifth embodiment.

FIG. 18 is a flow chart showing an engine torque estimating process according to a fifth embodiment.

FIG. 19 shows a diagram for explaining a problem which occurs in such a case that a predicted torque is different from an actual torque (and a detected torque).

FIG. 20 shows a diagram for concretely explaining an engine torque estimating method according to a sixth embodiment.

FIG. 21 is a flow chart showing an engine torque estimating process according to a sixth embodiment.

### DETAILED DESCRIPTION OF THE PREFERRED EMBODIMENTS

Preferred embodiments of the present invention will be explained hereinafter with reference to the drawings.

[Device Configuration]

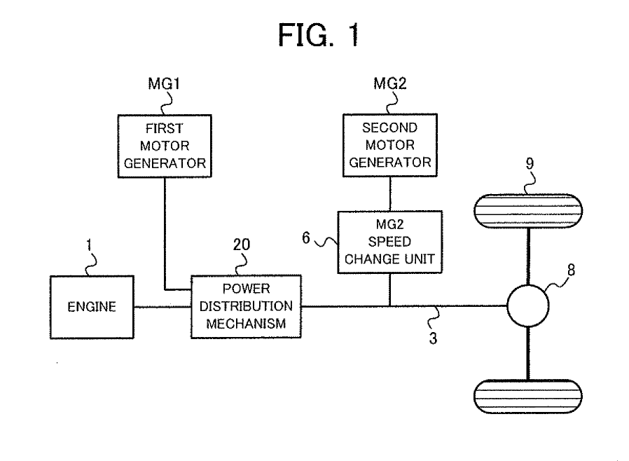

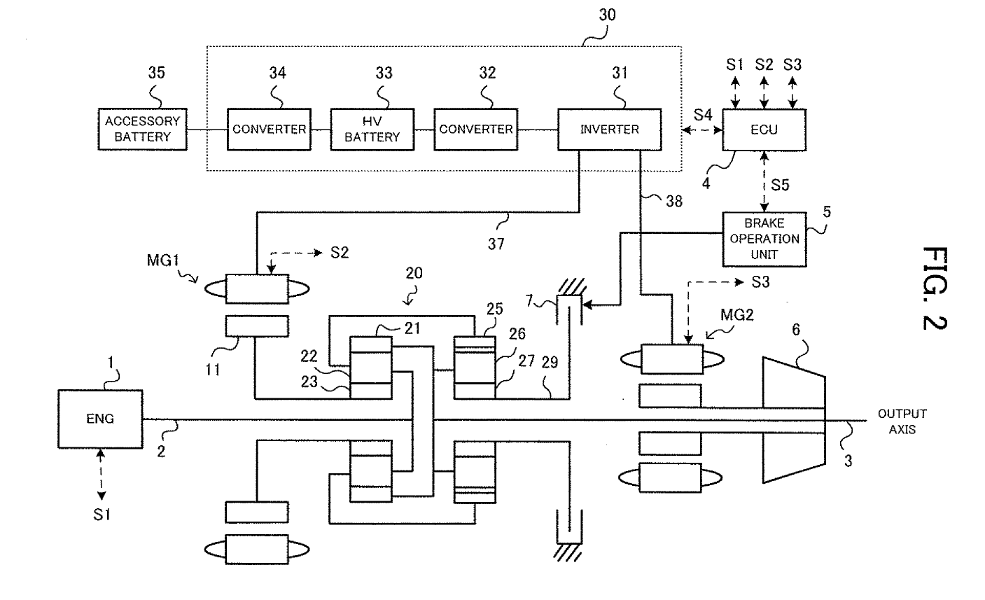

FIG. 1 shows a schematic configuration of a hybrid vehicle to which the present invention is applied. An example of FIG. 1 is the hybrid vehicle referred to as a mechanical distribution double-motor type, including an engine (internal combustion engine) 1, a first motor generator MG1, a second motor generator MG2 and a power distribution mechanism 20. The engine 1 serving as a power source and the first motor generator MG1 serving as a revolution number control mechanism are connected to the power distribution mechanism 20. The second motor generator MG2 serving as a sub power source for assisting a driving torque or a braking force is connected to the output axis 3 of the power distribution mechanism 20. The second motor generator MG2 and the output axis 3 are connected via a MG2 speed change unit 6. Further, the output axis 3 is connected to right and left driving wheels 9 via a final decelerator 8. The first motor generator MG1 and the second motor generator MG2 are electrically connected to each other via a battery, an inverter or an appropriate controller (see FIG. 2) or directly, and they are formed so that the power generated in the first motor generator MG1 drives the second motor generator MG2.

The engine 1 is a heat engine which combusts fuel and generates the power, e.g., a gasoline engine and a diesel engine. Mainly, the first motor generator MG1 receives the torque from the engine 1, and revolves to generate the power. At this time, reaction power of the torque caused by the power generation operates on the first motor generator MG1. By controlling the number of revolutions of the first motor generator MG1, the number of revolutions of the engine 1 continuously changes. Such a speed change mode is referred to as the infinite variable speed mode. The infinite variable speed mode is realized by a differential operation of the power distribution mechanism 20, which will be described later.

The second motor generator MG2 is the device which assists the driving torque or the braking force. When assisting the driving torque, the second motor generator MG2 receives the power supply to function as an electromotor. Meanwhile, when assisting the braking force, the second motor generator MG2 is revolved by the torque transmitted from the driving wheels 9, and functions as a generator which generates the power.

FIG. 2 shows the configuration of the first and second motor generators MG1 and MG2 and the power distribution mechanism 20, shown in FIG. 1.

The power distribution mechanism 20 distributes the output torque of the engine 1 to the first motor generator MG1 and the output axis 3, and is formed so that the differential operation occurs. Concretely, the power distribution mechanism 20 has a plural pairs of differential mechanisms, and in four revolution components mutually generating the differential operation, the engine 1 is connected to the first revolution component, and the first motor generator MG1 is connected to the second revolution component. Also, the output axis 3 is connected to the third revolution component. The fourth revolution component is fixable by the dog brake unit 7.

The dog brake unit 7 is formed as the engagement mechanism including the engaging component and the engaged component (which are not shown) having the plural teeth, and is controlled by the brake operation unit 5. For example, the engaging component is formed to be able to rotate and stroke. Instead of the dog brake unit 7, a clutch (dog clutch) which is formed to be able to engage rotating engaging components may be used. Hereinafter, the dog brake unit 7 and the dog clutch will be simply referred to as “dog unit”.

In such a state that the dog brake unit 7 does not fix the fourth revolution component, the number of revolutions of the engine 1 continuously changes by continuously changing the number of revolutions of the first motor generator MG1, and the infinite variable speed mode is realized. Meanwhile, in such a state that the dog brake unit 7 fixes the fourth revolution component, the speed gear ratio determined by the power distribution mechanism 20 is fixed in an overdrive state (i.e., in such a state that the number of engine revolutions becomes smaller than the number of output revolutions), and the fixed gear ratio mode is realized.

In this embodiment, as shown in FIG. 2, the power distribution mechanism 20 is formed by combining two planetary gear mechanisms. The first planetary gear mechanism includes a ring gear 21, a carrier 22 and a sun gear 23. The second planetary gear mechanism, which is a double-pinion type, includes a ring gear 25, a carrier 26 and a sun gear 27.

The output axis 2 of the engine 1 is connected to the carrier 22 of the first planetary gear mechanism, and the carrier 22 is connected to the ring gear 25 of the second planetary gear mechanism. They form the first revolution component. A rotor 11 of the first motor generator MG1 is connected to the sun gear 23 of the first planetary gear mechanism. They form the second revolution component.

The ring gear 21 of the first planetary gear mechanism and the carrier 26 of the second planetary gear mechanism are connected to each other, and are also connected to the output axis 3. They form the third revolution component. Further, the sun gear 27 of the second planetary gear mechanism is connected to the revolution axis 29. They form the fourth revolution component with the revolution axis 29. The revolution axis 29 is fixable by the dog brake unit 7.

A power source unit 30 includes an inverter 31, a converter 32, an HV battery 33 and a converter 34. The first motor generator MG1 is connected to the inverter 31 by a power source line 37, and the second motor generator MG2 is connected to the inverter 31 by a power source line 38. In addition, the inverter 31 is connected to the converter 32, and the converter 32 is connected to the HV battery 33. Moreover, the HV battery 33 is connected to an accessory battery 35 via the converter 34.

The inverter 31 gives and receives the power to and from the motor generators MG1 and MG2. At the time of regenerating the motor generators, the inverter 31 converts, to the direct current, the power generated by the regeneration of the motor generators MG1 and MG2, and supplies it to the converter 32. The converter 32 converts the voltage of the power supplied from the inverter 31, and charges the HV battery 33. Meanwhile, at the time of powering the motor generators, the voltage of the direct current power outputted from the HV battery 33 is raised by the converter 32, and is supplied to the motor generator MG1 or MG2 via the power source line 37 or 38.

The voltage of the power of the HV battery 33 is converted by the converter 34, and is supplied to the accessory battery 35 to be used for driving various kinds of accessories.

The operations of the inverter 31, the converter 32, the HV battery 33 and the converter 34 are controlled by an ECU 4. The ECU 4 transmits a control signal S4, and controls the operation of each of the components in the power source unit 30. In addition, the signal necessary to show the state of each component in the power source unit 30 is supplied to the ECU 4 as the control signal S4. Concretely, a SOC (State Of Charge) showing the state of the HV battery 33 and an input/output limit value of the battery are supplied to the ECU 4 as the control signal S4.

The ECU 4 transmits and receives control signals S1 to S3 with the engine 1, the first motor generator MG1 and the second motor generator MG2, and controls them. In addition, the ECU 4 supplies a brake operation instruction signal S5 to the brake operation unit 5. The brake operation unit 5 controls engagement (fixation)/release of the dog brake unit 7 in accordance with the brake operation instruction signal S5. The ECU 4 functions as a variation estimating device of object in the present invention, which will be described in details, later.

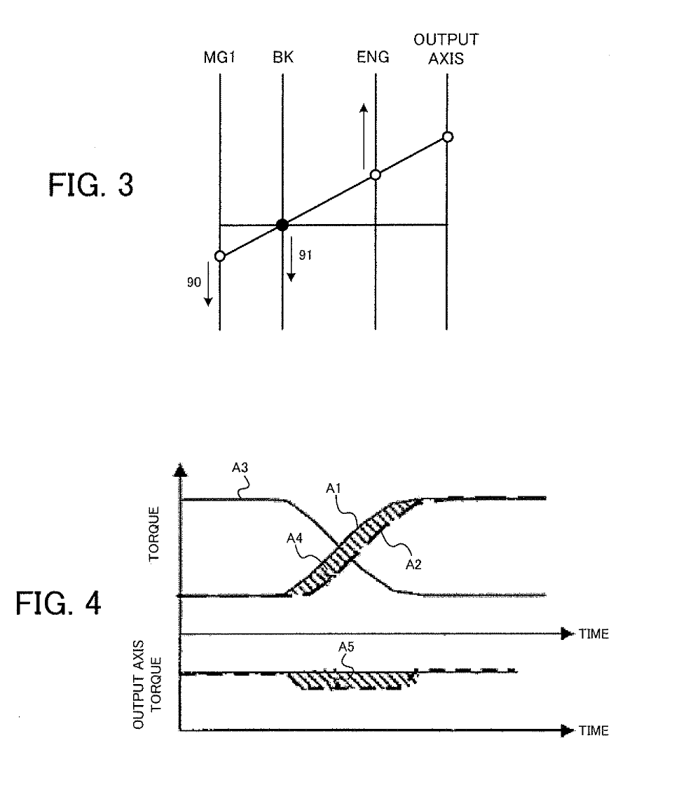

FIG. 3 shows an alignment chart in the fixed gear ratio mode of the power distribution mechanism 20. In the fixed gear ratio mode, as shown by a black dot in FIG. 3, the dog teeth of the engaging component and the dog teeth of the engaged component are engaged and the dog brake unit 7 is fixed. In the infinite variable speed mode, as shown by an arrow 90, the reaction force of the engine torque is supported by the first motor generator MG1. Though FIG. 3 shows the alignment chart in the fixed gear ratio mode, as a matter of convenience of the explanations, the description is given of the infinite variable speed mode using this figure. On the other hand, in the fixed gear ratio mode, as shown by an arrow 91, the reaction force of the engine torque is mechanically supported by the dog brake unit 7.

[Engine Torque Estimating Method]

Next, a description will be given of the engine torque estimating method performed by the ECU 4 in the embodiment. In the embodiment, the ECU 4 estimates the engine torque in order to obtain the engine torque with high accuracy.

The reason is as follows. When the speed change is performed by using the first motor generator MG1 in the hybrid vehicle, the user sometimes feels the delay of the speed change and/or the shock (hereinafter referred to as “speed change shock”). Additionally, since the restriction of the use of the battery becomes severe in the hybrid vehicle due to the decrease of the accuracy of the control of the discharge and charge of the battery at the time of the transient state in which the engine speed and the engine torque vary, there is a case that the potential of the battery cannot be drawn out. It is thought that the problem occurs due to the decrease of the estimation accuracy of the variation of the engine torque at the time of the transient state.

FIG. 4 represents a conceptual diagram showing an example of a relationship between the speed change control and the speed change shock in the hybrid vehicle. In FIG. 4, a horizontal axis shows time, and a vertical axis shows a torque. Concretely, graphs A1, A2 show contribution parts of the engine torque with respect to the output axis torque. The graph A1 shows the engine torque (corresponding to an engine torque estimated by a second estimating method, which will be described later) estimated based on the intake air amount of the engine, and the graph A2 shows an actual engine torque. Additionally, a graph A3 shows a contribution part of the torque of the first motor generator MG1 with respect to the output axis torque. The torque is adjusted based on the torque shown by the graph A1. In this case, as shown by a hatching area A4, it can be understood that an estimation error of the engine torque occurs. As a result, as shown by a hatching area A5, the level difference of the output axis torque (i.e., speed change shock) occurs. So, it can be said that the estimation accuracy of the engine torque influences the quality of the speed change.

Thus, in the embodiment, the ECU 4 estimates the engine torque in order to obtain the engine torque with high accuracy. Concretely, the ECU 4 uses the engine torque estimating method (hereinafter referred to as “first estimating method”) based on the disturbance observer and the engine torque estimating method (hereinafter referred to as “second estimating method”) based on the intake air amount of the engine, in order to estimate the engine torque. The first estimating method corresponds to a method for estimating the disturbance torque value with respect to the revolution control of the first motor generator MG1. Namely, the first estimating method corresponds to the method for estimating the previous torque based on the variation amount of the number of revolutions of the first motor generator MG1 connected to the engine 1. The second estimating method corresponds to a method for estimating the engine torque by predicting the filled amount of the intake air of the engine. It is prescribed that “estimating” according to the first estimating method is a concept in which “obtaining” and/or “detecting” can be included.

Here, since the first estimating method estimates the engine torque by using information of the number of revolutions of the first motor generator MG1, the first estimating method can obtain the value with relatively high accuracy. Namely, it can be said that the estimation of the engine torque by the first estimating method corresponds to the detection of the engine torque by using the sensor. However, the first estimating method performs differentiation in the operation process, and hence it is practically necessary to use the filter (differentiation noise eliminating filter) to eliminate the noise caused by the differentiation. Therefore, the method obtains the value having the delay with respect to the actual variation of the engine torque.

Meanwhile, the second estimating method can estimate the engine torque which is going to be output, based on the order value of the engine power and/or the order value of the number of engine revolutions. Namely, it can be said that the second estimating method predicts the future engine torque. However, since the second estimating method is influenced by the friction variation and/or the combustion state variation depending upon the temperature of the engine and/or the cooling water, for example, there is a case that the engine torque cannot be accurately estimated.

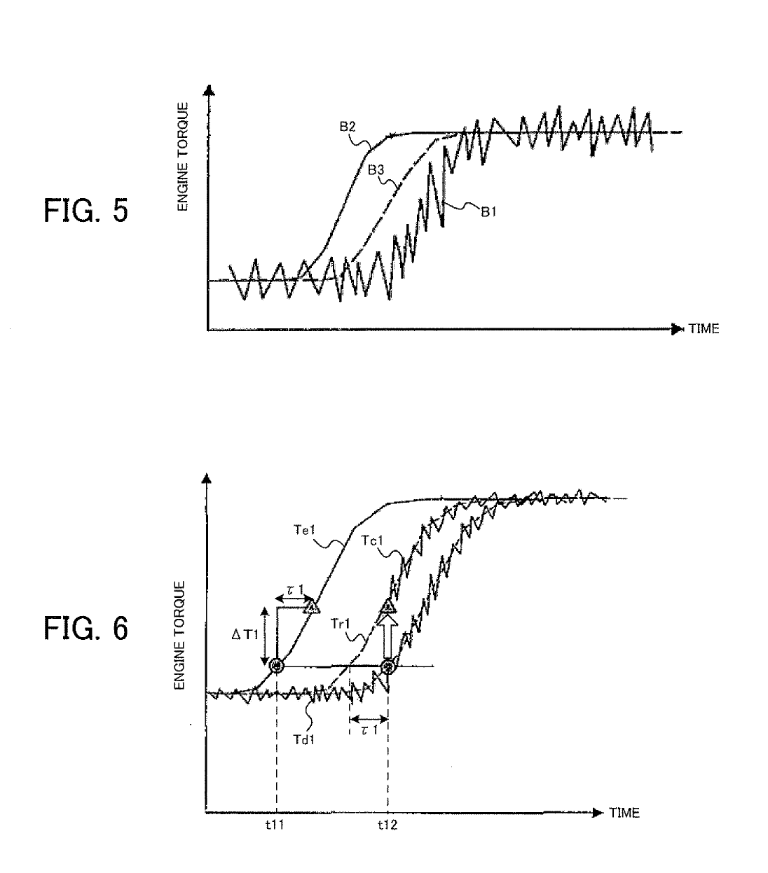

FIG. 5 shows an example of the engine torque estimated by the first and second estimating methods. In FIG. 5, a horizontal axis shows time, and a vertical axis shows an engine torque. Concretely, graph B1 shows the engine torque estimated by the first estimating method, and graph B2 shows the engine torque estimated by the second estimating method, and graph B3 shows the actual engine torque. As shown in FIG. 5, it can be understood that the engine torque estimated by the first estimating method is delayed with respect to the actual engine torque. Though FIG. 5 shows the diagram in which the variation of the engine torque estimated by the second estimating method approximately coincides with the actual variation of the engine torque, as a matter of convenience of the explanations, the variation of the engine torque estimated by the second estimating method actually tends to be different from the actual variation of the engine torque at the time of the speed change, for example.

Thus, in the embodiment, in order to grasp the actual engine torque as shown by the graph B3 in FIG. 5 in real time, the ECU 4 estimates the engine torque by using both the first estimating method and the second estimating method. Concretely, by the engine torque estimated by the second estimating method, the ECU 4 corrects the engine torque estimated by the first estimating method, so as to calculate the present engine torque. Afterward, by using the calculated engine torque, the ECU 4 performs the speed change control, for example. Thus, the ECU 4 functions as the first estimating unit, the second estimating unit and the correcting unit in the present invention.

Hereinafter, a concrete description will be given of embodiments (first to sixth embodiments) regarding the engine torque estimating method.

### First Embodiment

In a first embodiment, the ECU 4 calculates a variation amount of the engine torque after a delay time of the estimation by the first estimating method with respect to the actual variation of the engine torque, by using the second estimating method. Then, the ECU 4 adds the calculated variation amount of the engine torque to the engine torque estimated by the first estimating method, or subtracts the calculated variation amount of the engine torque from the engine torque estimated by the first estimating method, so as to calculate the engine torque. Concretely, by the first estimating method, the ECU 4 detects the same variation as the variation of the engine torque estimated by the second estimating method, in order to synchronize two engine torque information estimated by the first and second estimating methods. Afterward, the ECU 4 calculates the variation amount of the engine torque after the delay time of the first estimating method, based on the engine torque by the synchronized second estimating method, and adds the calculated variation amount of the engine torque to the engine torque estimated by the first estimating method, or subtracts the calculated variation amount of the engine torque from the engine torque estimated by the first estimating method. Therefore, it is possible to improve the estimation accuracy of the transient engine torque.

Hereinafter, the engine torque estimated by the first estimating method will be suitably referred to as “detected torque”. The engine torque estimated by the second estimating method will be suitably referred to as “predicted torque”. The actual engine torque will be suitably referred to as “actual torque”. The above variation amount of the engine torque which is added to the engine torque (detected torque) estimated by the first estimating method or is subtracted from the engine torque (detected torque) estimated by the first estimating method will be suitably referred to as “correction torque”. The engine torque which is obtained by correcting the detected torque by the correction torque will be suitably referred to as “calculated torque”.

FIG. 6 is a diagram for concretely explaining the engine torque estimating method according to the first embodiment. In FIG. 6, a horizontal axis shows time, and a vertical axis shows an engine torque. Concretely, a graph Te1 shows an example of the predicted torque, and a graph Td1 shows an example of the detected torque. A graph Tr1 shows an example of the actual torque, and a graph Tc1 shows an example of the calculated torque.

A concrete description will be given of the calculating method of the calculated torque Tc1 according to the first embodiment. When the variation of the predicted torque Te1 becomes larger than a threshold value (hereinafter referred to as “first predetermined value”), the ECU 4 starts a process for correcting the detected torque Td1. In addition, when the variation of the predicted torque Te1 becomes larger than the first predetermined value, the ECU 4 stores the predicted torque Te1 at the time. In the example shown in FIG. 6, since the variation of the predicted torque Te1 becomes larger than the first predetermined value at time t11, the ECU 4 stores the predicted torque Te1 at the time t11.

Additionally, the ECU 4 detects the same variation as the variation of the above predicted torque Te1, from the detected torque Td1. Hereinafter, the above detection will be referred to as “rise-up detection”. Concretely, the ECU 4 determines whether or not the variation of the detected torque Td1 is larger than a threshold value (hereinafter referred to as “second predetermined value”), so as to perform the rise-up detection. In addition, when the variation of the detected torque Td1 becomes larger than the second predetermined value (i.e., when the rise-up is detected), the ECU 4 stores the detected torque Td1 at the time. In the example shown in FIG. 6, since the variation of the detected torque Td1 becomes larger than the second predetermined value at time t12, the ECU 4 stores the detected torque Td1 at the time t12.

Next, at the time t12 when the above rise-up is detected, the ECU 4 synchronizes two torques on the basis of the stored predicted torque Te1 and the stored detected torque Td1. Then, by using a delay time τ1 of the estimation by the first estimating method with respect to the actual variation of the engine torque, the ECU 4 calculates a variation amount ΔT1 of the engine torque until the delay time τ1 elapses from the time t11, based on the synchronized predicted torque Te1. The variation amount ΔT1 of the engine torque corresponds to the correction torque. The delay time τ1 corresponds to a delay characteristic value of the disturbance observer of the first estimating method. Specifically, the delay time τ1 corresponds to a filter time constant of the disturbance observer. For example, a first order lag filter is used as the filter of the disturbance observer.

Next, as shown by a white arrow in FIG. 6, the ECU 4 adds the above calculated correction torque ΔT1. to the detected torque Td1 in order to correct the detected torque Td1. Thereby, the calculated torque Tc1 is obtained. Only when an absolute value of the correction torque ΔT1 is larger than a threshold value (hereinafter referred to as “third predetermined value”), the ECU 4 performs the above correction. The third predetermined value is preliminarily set in accordance with a necessary accuracy.

Though FIG. 6 shows the diagram in which the value of the predicted torque Te1 approximately coincides with the value of the actual torque Tr1 (in details, the value of the predicted torque Te1 is different from the value of the actual torque Tr1 only on the time axis), the value of the predicted torque Te1 actually tends to be different from the value of the actual torque Tr1. Concretely, there is a case that the value of the predicted torque Te1 is different from the value of the actual torque Tr1 on the torque axis, too.

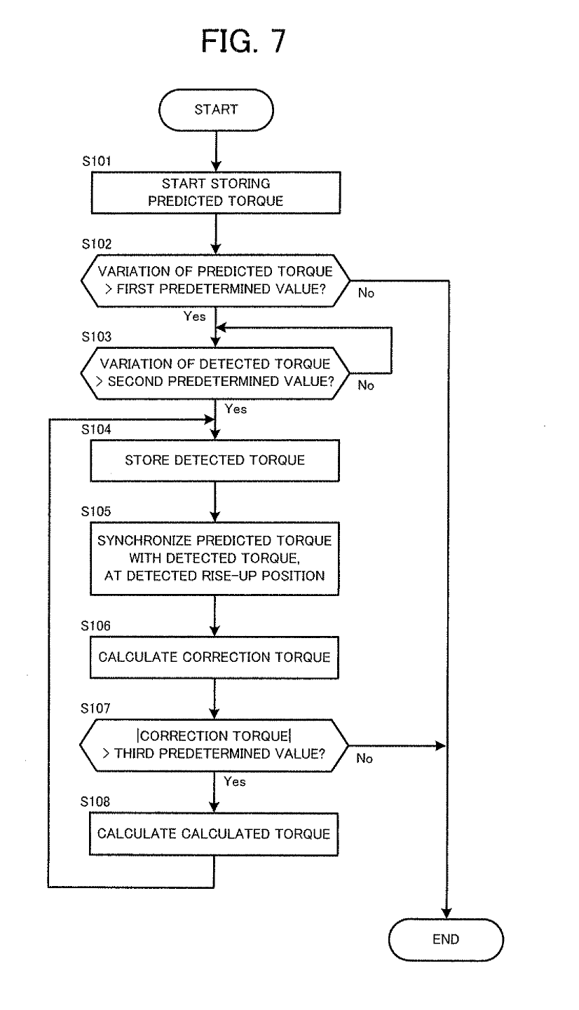

FIG. 7 is a flow chart showing an engine torque estimating process according to the first embodiment. The process is repeatedly executed by the ECU 4.

First, in step S101, the ECU 4 starts storing the predicted torque estimated by the second estimating method. Then, the process goes to step S102. In step S102, the ECU 4 determines whether or not the variation of the predicted torque is larger than the first predetermined value. When the variation of the predicted torque is larger than the first predetermined value (step S102; Yes), the process goes to step S103. In this case, the ECU 4 starts the process for correcting the detected torque. In contrast, when the variation of the predicted torque is equal to or smaller than the first predetermined value (step S102; No), the process ends without starting the process for correcting the detected torque.

In step S103, the ECU 4 determines whether or not the variation of the detected torque estimated by the first estimating method is larger than the second predetermined value. By performing the determination, the ECU 4 performs the rise-up detection of the detected torque. When the variation of the detected torque is larger than the second predetermined value (step S103; Yes), the process goes to step S104. In this case, since it can be said that the detected torque rises up, the ECU 4 stores the detected torque (step S104). Then, the process goes to step S105. In contrast, when the variation of the detected torque is equal to or smaller than the second predetermined value (step S103; No), since it cannot be said that the detected torque rises up, the process goes back to step S103.

In step S105, the ECU 4 synchronizes two engine torques at the detected rise-up position, on the basis of the predicted torque stored in step S101 and the detected torque stored in step S104. Then, the process goes to step S106. In step S106, the ECU 4 calculates the correction torque for correcting the detected torque. Concretely, by using the delay time of the estimation by the first estimating method with respect to the actual variation of the engine torque, the ECU 4 calculates the variation amount of the engine torque after the delay time, based on the synchronized predicted torque, and the ECU 4 uses the variation amount of the engine torque as the correction torque. Then, the process goes to step S107.

In step S107, the ECU 4 determines whether or not the absolute value of the correction torque calculated in step S106 is larger than the third predetermined value. When the absolute value of the correction torque is larger than the third predetermined value (step S107; Yes), the process goes to step S108. In step S108, the ECU 4 corrects the detected torque based on the correction torque. Namely, the ECU 9 adds the correction torque calculated in step S106 to the detected torque stored in step S104, so as to calculate the calculated torque. Then, the process goes back to step S104. In contrast, when the absolute value of the correction torque is equal to or smaller than the third predetermined value (step S107; No), the process ends. In this case, the detected torque is not corrected.

By the above engine torque estimating method according to the first embodiment, it is possible to improve the detection accuracy of the transient variation of the engine torque. In addition, by performing the speed change control by using the above estimated engine torque, it is possible to improve the quality of the speed change in the hybrid vehicle and improve the responsiveness of the control of the discharge and charge of the battery.

The above embodiment shows the engine torque estimating method which is performed when the engine torque rises up. The estimating method can be similarly performed when the engine torque falls down, too. In this case, by subtracting the correction torque from the detected torque by the first estimating method, the detected torque can be corrected.

### Second Embodiment

Next, a description will be given of an engine torque estimating method according to a second embodiment. In the second embodiment, the same method as the engine torque estimating method according to the first embodiment is basically used, too. However, the second embodiment is different from the first embodiment in that, based on a gradient of the variation of the predicted torque, the second predetermined value for detecting the rise-up of the detected torque is changed and a filter time constant of the disturbance observer (in other words, a filter lag of the disturbance observer) of the first estimating method is changed. Namely, in the second embodiment, the ECU 4 changes the second predetermined value and the filter time constant of the disturbance observer in accordance with the variation gradient of the predicted torque so that the threshold value (second predetermined value) for detecting the rise-up of the detected torque exceeds a variation by a noise of the disturbance observer.

The reason is as follows. In the above engine torque estimating method according to the first embodiment, if the filter time constant which makes the lag of the disturbance observer smaller is selected (i.e., if the filter time constant having the relatively small value is selected), the disturbance by the noise tends to become larger. Therefore, there is a case that it is difficult to appropriately synchronize two engine torque information, i.e., it is difficult to appropriately detect the rise-up of the detected torque. In contrast, if the filter time constant which makes the disturbance by the noise smaller is selected (i.e., if the filter time constant having the relatively large value is selected), the lag of the disturbance observer tends to become larger. Therefore, the time period in which the detected torque is appropriately corrected tends to become shorter. So, there is a case that it is impossible to appropriately deal with the rapid variation of the engine torque.

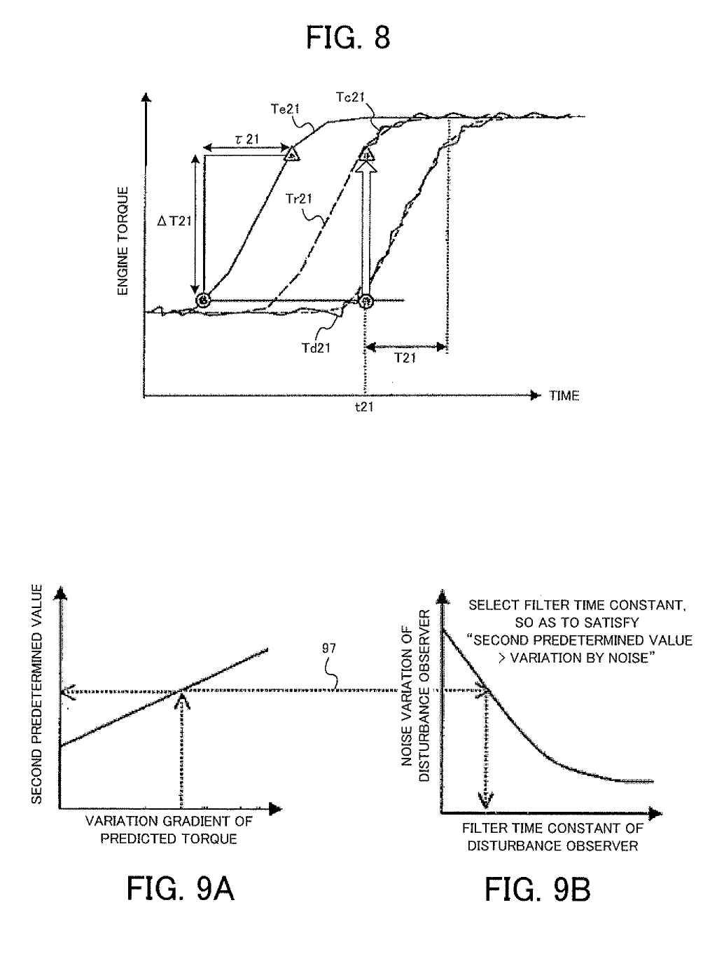

A concrete description will be given, with reference to FIG. 8. FIG. 8 is a diagram for explaining a problem in such a case that the second predetermined value for detecting the rise-up of the detected torque is relatively small and the filter time constant of the disturbance observer is large (i.e., the filter lag is large). In FIG. 8, a horizontal axis shows time, and a vertical axis shows an engine torque. Concretely, a graph Te21 shows an example of the predicted torque, and a graph Td21 shows an example of the detected torque. A graph Tr21 shows an example of the actual torque, and a graph Tc21 shows an example of the calculated torque. The calculated torque Tc21 is calculated based on the correction torque ΔT21 corresponding to the delay time τ 21, by the same method as the engine torque estimating method according to the first embodiment.

In this case, since the second predetermined value is relatively small and the filter time constant of the disturbance observer (corresponding to the delay time τ21) is large, as shown by an arrow T21 in FIG. 8, it can be understood that the time period in which the detected torque Td21 is appropriately corrected is short. In other words, it can be understood that the timing when the application of the calculated torque Tc21 is started is late.

Thus, in the second embodiment, in order to solve the above problem, the ECU 4 changes the second predetermined value and the filter time constant of the disturbance observer, based on the variation gradient of the predicted torque. Concretely, in accordance with the variation gradient of the predicted torque, the ECU 4 changes the second predetermined value and the filter time constant of the disturbance observer, so as to satisfy “ (second predetermined value)>(variation by noise of disturbance observer)”.

FIGS. 9A and 9B are diagrams for explaining a method for determining the second predetermined value and the filter time constant of the disturbance observer in the second embodiment. FIG. 9A shows an example of a relationship between the variation gradient of the predicted torque (horizontal axis) and the second predetermined value (vertical axis). According to the relationship, based on the variation gradient of the predicted torque, the second predetermined value corresponding to the gradient is determined. In this case, it can be understood that the second predetermined value having the smaller value is determined as the variation gradient of the predicted torque becomes smaller, and the second predetermined value having the larger value is determined as the variation gradient of the predicted torque becomes larger.

FIG. 9B shows an example of a relationship between the filter time constant of the disturbance observer (horizontal axis) and the noise variation of the disturbance observer (vertical axis). As shown by an arrow 97, the noise variation of the disturbance observer is determined in accordance with the second predetermined value. Thereby, the second predetermined value is determined by the variation gradient of the predicted torque, and the noise variation corresponding to the second predetermined value is determined. Then, based on the determined noise variation, the filter time constant of the disturbance observer corresponding to the noise variation is determined. In this case, the filter time constant having the larger value is determined as the noise variation becomes smaller, and the filter time constant having the smaller value is determined as the noise variation becomes larger.

Therefore, the filter time constant having the larger value is determined as the variation gradient of the predicted torque becomes smaller, and the filter time constant having the smaller value is determined as the variation gradient of the predicted torque becomes larger. So, it becomes possible to appropriately realize the detection of the small variation when the variation gradient of the predicted torque is small, and appropriately realize the early detection when the variation gradient of the predicted torque is large. The relationships shown in FIGS. 9A and 9B are preliminary determined, so as to satisfy “(second predetermined value)>(variation by noise of disturbance observer)”.

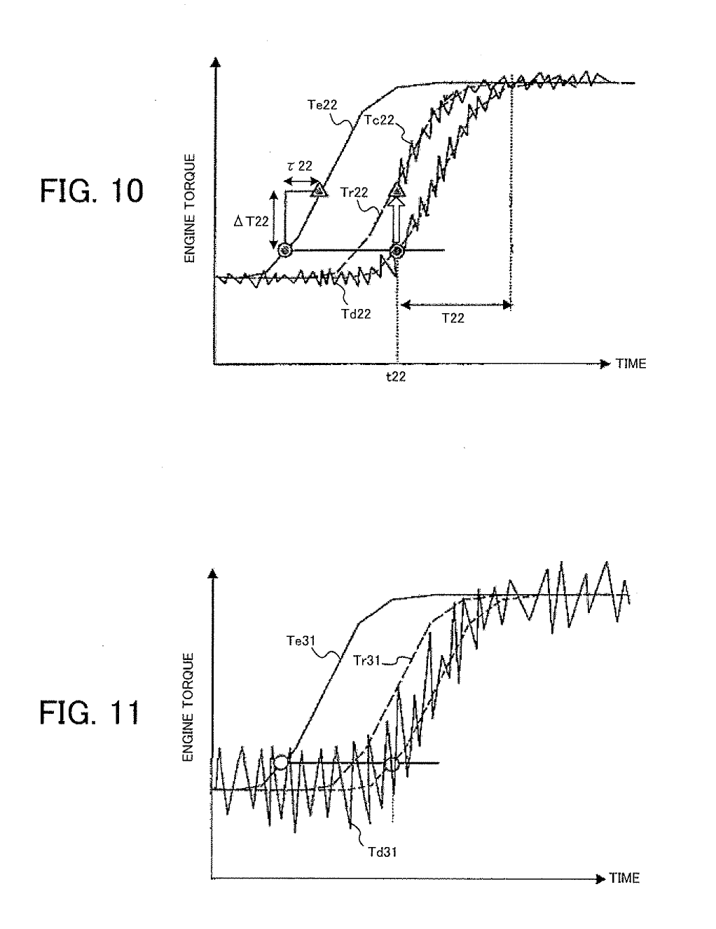

FIG. 10 is a diagram for explaining an effect of the engine torque estimating method according to the second embodiment. In FIG. 10, a horizontal axis shows time, and a vertical axis shows an engine torque. Concretely, a graph Te22 shows an example of the predicted torque, and a graph Td22 shows an example of the detected torque. A graph Tr22 shows an example of the actual torque, and a graph Tc22 shows an example of the calculated torque. The calculated torque Tc22 is calculated based on the correction torque ΔT22 corresponding to the delay time τ22, by the same method as the engine torque estimating method according to the first embodiment.

In this case, by the above-mentioned method, it is assumed that the second predetermined value having the relatively large value and the filter time constant having the relatively small value are determined in accordance with the variation gradient of the predicted torque. Therefore, as shown by an arrow T22 in FIG. 10, it can be understood that the time period in which the detected torque Td22 is appropriately corrected is long. Concretely, the time period in which the detected torque Td22 is corrected is longer than the time period in which the detected torque Td21 shown in FIG. 8 is corrected.

By the above engine torque estimating method according to the second embodiment, it is possible to further improve the detection accuracy of the transient variation of the engine torque.

The above embodiment shows the engine torque estimating method which is performed when the engine torque rises up. The estimating method can be similarly performed when the engine torque falls down, too. Namely, by a similar manner, when the engine torque falls down, a threshold value (a value, the absolute value of which is the same as that of the second predetermined value, may be used) for detecting the fall-down of the detected torque can be changed, and the filter time constant of the disturbance observer of the first estimating method can be changed, based on the variation gradient of the predicted torque, too.

The above embodiment shows such an example that both the second predetermined value and the filter time constant of the disturbance observer are changed based on the variation gradient of the predicted torque. However, only one of the second predetermined value and the filter time constant of the disturbance observer may be changed based on the variation gradient of the predicted torque.

### Third Embodiment

Next, a description will be given of an engine torque estimating method according to a third embodiment. In the third embodiment, the same method as the engine torque estimating method according to the first embodiment is basically used, too. However, the third embodiment is different from the first and second embodiments in that a lower limit guard value of the filter time constant of the disturbance observer is set in consideration of a characteristic of the cause of the noise of the disturbance observer according to the first estimating method, and a control of the engine torque is performed so that the filter time constant complies with the lower limit guard value. Namely, as for the engine torque estimating method according to the second embodiment, the ECU 4 prohibits the order of the variation gradient of the engine torque, which requires the filter time constant below the set lower limit guard value (in other words, the variation gradient of the engine torque is restricted).

Specifically, at first, the ECU 4 sets the lower limit guard value of the filter time constant of the disturbance observer based on the noise characteristic of the operation point, and calculates the variation gradient of the engine torque which can be detected by the set lower limit guard value. Then, the ECU 4 restricts the order of the engine torque so that the engine torque variation exceeding the calculated variation gradient is not generated.

The reason is as follows. When the torque variation is large (i.e., when the variation by the noise is large), it can be said that it is necessary to make the filter time constant larger in order to eliminate the noise. Meanwhile, when the gradient of the torque variation is large (i.e., when the variation gradient of the predicted torque is large), it is necessary to make the filter time constant smaller in order to shorten the time of the rise-up detection. Therefore, when the torque variation is large and the gradient of the torque variation is large, it is thought that the condition in which it is impossible to balance the elimination of the noise with the shortening of the time of the rise-up detection occurs. So, by the method according to the second embodiment, when the variation gradient of the predicted torque is large and/or the variation by the noise of the disturbance observer is large, it can be said that there is a case that it is impossible to appropriately select the second predetermined value and the filter time constant of the disturbance observer so as to satisfy “(second predetermined value)>(variation by noise of disturbance observer)”.

A concrete description will be given, with reference to FIG. 11. FIG. 11 is a diagram for explaining a problem in such a case that the torque variation is large and the gradient of the torque variation is large. In FIG. 11, a horizontal axis shows time, and a vertical axis shows an engine torque. Concretely, a graph Te31 shows an example of the predicted torque, and a graph Td31 shows an example of the detected torque, and a graph Tr31 shows an example of the actual torque. In this case, since the torque variation is large and the gradient of the torque variation is large, it can be said that the condition in which it is impossible to balance the elimination of the noise with the shortening of the time of the rise-up detection occurs. Therefore, by the second predetermined value which is determined from the variation gradient of the predicted torque by the method shown in the second embodiment, it is thought that the noise is so large that the rise-up of the detected torque Td31 cannot be appropriately detected.

Thus, in the third embodiment, in order to solve the problem, the ECU 4 sets the lower limit guard value of the filter time constant of the disturbance observer, and prohibits the order of the variation gradient of the engine torque, which requires the filter time constant below the set lower limit guard value. Basically, in consideration of a characteristic of the exhaust gas based on a characteristic of the response bounds of the engine torque and/or a catalyst composition, the most gradual variation gradient of the engine torque is ordered. However, in the third embodiment, in addition to this, the configuration of the first estimating method by the disturbance observer is considered as the sensor, and the variation gradient of the engine torque is ordered in consideration of the accuracy of the sensor, too. Namely, the order of the variation gradient of the engine torque by which the accuracy of the sensor cannot be ensured is prohibited.

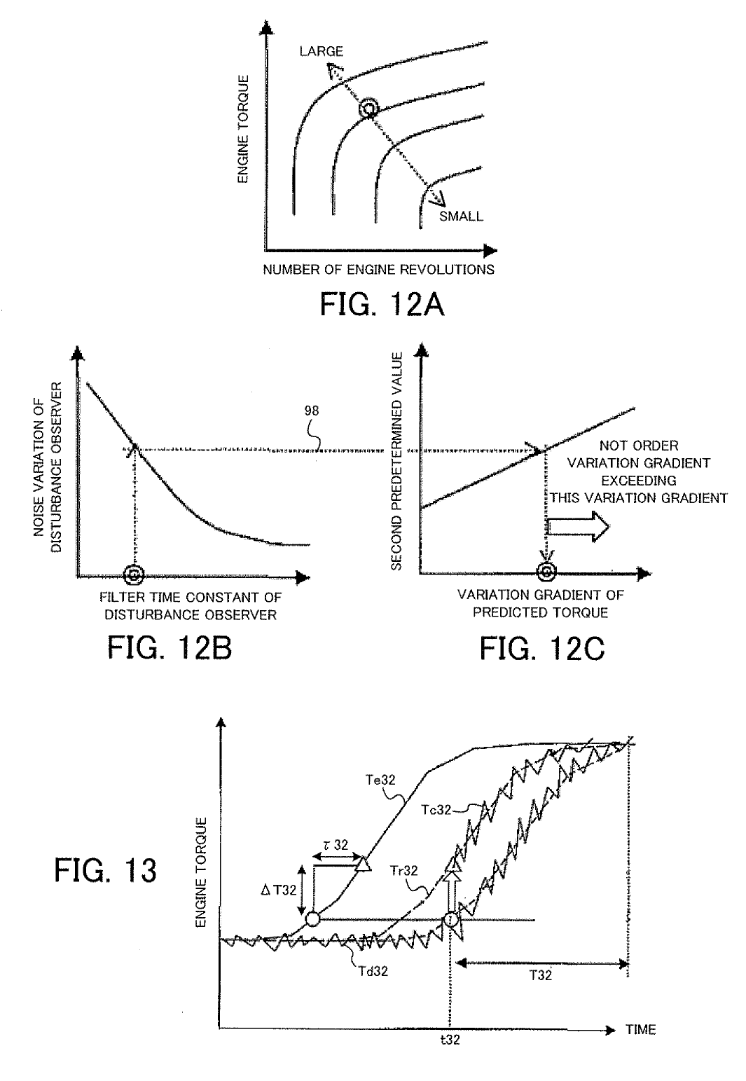

FIGS. 12A to 120 are diagrams for concretely explaining the method for restricting the variation gradient of the engine torque, in the third embodiment. In FIG. 12A, a horizontal axis shows a number of engine revolutions, and a vertical axis shows an engine torque. FIG. 12A shows a diagram for determining the lower limit guard value of the filter time constant of the disturbance observer. Concretely, by the contour line, FIG. 12A shows the characteristic of the torque variation with respect to the operation point of the engine. Based on the characteristic of the torque variation, the lower limit guard value of the filter time constant is selected.

FIG. 12B shows an example of a relationship between the filter time constant of the disturbance observer (horizontal axis) and the noise variation of the disturbance observer (vertical axis). According to the relationship, based on the selected lower limit guard value of the filter time constant of the disturbance observer, the noise variation corresponding to the lower limit guard value is determined.

FIG. 12C shows an example of a relationship between the variation gradient of the predicted torque (horizontal axis) and the second predetermined value (vertical axis). As shown by an arrow 98, the second predetermined value is determined in accordance with the noise variation of the disturbance observer. Thereby, the noise variation is determined by the lower limit guard value of the filter time constant, and the second predetermined value corresponding to the noise variation is determined. This manner corresponds to the calculation of a threshold value by which the rise-up of the detected torque can be appropriately detected. Then, based on the determined second predetermined value, the variation gradient of the predicted torque corresponding to the second predetermined value is determined. In the third embodiment, as shown by a white arrow in FIG. 12C, the ECU 4 does not order the engine torque, the variation gradient of which is larger than the determined variation gradient.

FIG. 13 is a diagram for explaining an effect of the engine torque estimating method according to the third embodiment. In FIG. 13, a horizontal axis shows time, and a vertical axis shows an engine torque. Concretely, a graph Te32 shows an example of the predicted torque, and a graph Td32 shows an example of the detected torque. A graph Tr32 shows an example of the actual torque, and a graph Tc32 shows an example of the calculated torque. The calculated torque Tc32 is calculated based on the correction torque ΔT32 corresponding to the delay time τ32, by the same method as the engine torque estimating method according to the first embodiment. The time period T32 is the applicable period of the calculated torque Tc32.

In this case, since the variation gradient of the engine torque is restricted by the above method, as shown in the predicted torque Te32, it can be understood that the variation gradient of the torque becomes gradual. Therefore, it can be understood that the rise-up of the detected torque Td32 is appropriately detected and the detected torque Td32 is appropriately corrected.

By the above engine torque estimating method according to the third embodiment, it is possible to appropriately restrict the variation gradient of the engine torque. Therefore, it becomes possible to improve the detection accuracy of the transient variation of the engine torque.

The above embodiment shows the engine torque estimating method which is performed when the engine torque rises up. The estimating method can be similarly performed when the engine torque falls down, too. Namely, by a similar manner, when the engine torque falls down, the lower limit guard value of the filter time constant of the disturbance observer can be set, and the order of the variation gradient of the engine torque which requires the filter time constant below the lower limit guard value can be prohibited, too.

### Fourth Embodiment

Next, a description will be given of an engine torque estimating method according to a fourth embodiment. In the fourth embodiment, the same method as the engine torque estimating method according to the first embodiment is basically used, too. The fourth embodiment is different from the first to third embodiments in that, when the speed change from the infinite variable speed mode to the fixed gear ratio mode is performed, the correction of the detected torque is continued until the engagement of the dog unit (see FIG. 2) is completed. Namely, in the fourth embodiment, even after the components of the dog unit are once synchronized, the ECU 4 continues the correction of the detected torque for the variation of the engine torque, until the engagement of the dog unit is completed. The reason is as follows. As for the configuration which performs the synchronization engagement of the dog unit after the speed change, if the correction of the detected torque is performed by the above method, it is impossible to estimate the early behavior of the engine torque variation with high accuracy until the predicted torque and the detected torque are synchronized, when the gradient of the engine torque is varied. Therefore, the completion of the speed change is delayed, and/or the speed change shock occurs.

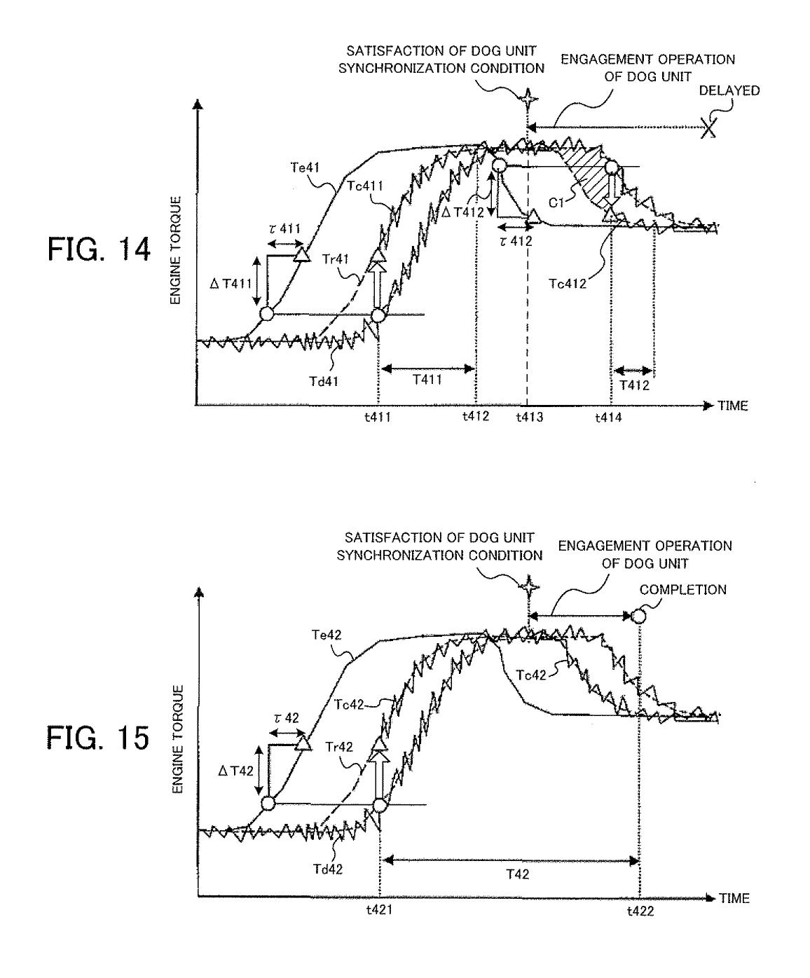

A concrete description will be given, with reference to FIG. 14. FIG. 14 is a diagram for explaining a problem which occurs in such a case that the correction of the detected torque is not continued until the engagement of the dog unit is completed. In FIG. 14, a horizontal axis shows time, and a vertical axis shows an engine torque. Concretely, a graph Te41 shows an example of the predicted torque, and a graph Td41 shows an example of the detected torque. A graph Tr41 shows an example of the actual torque, and graphs Tc411 and Tc412 show examples of the calculated torque.

The calculated torque Tc411 is calculated based on the correction torque ΔT411 corresponding to the delay time τ411, by the same method as the engine torque estimating method according to the first embodiment. The calculated torque Tc411 is applied during the time period T411. Concretely, the application of the calculated torque Tc411 ends at time t412. Though the synchronization condition of the dog unit is satisfied at time t413 after the time t412 and the engagement operation of the dog unit is performed, the detected torque Td41 is not corrected for a while from the time t413. Afterward, at time t414, since the fall-down of the detected torque Td41 is detected, the detected torque Td41 is corrected once again. Concretely, based on the correction torque ΔT412 corresponding to the delay time τ412, the calculated torque Tc412 is calculated. The calculated torque Tc412 is applied during the time period T412.

In this case, since the torque variation occurs during the engagement operation after the synchronization condition of the dog unit is satisfied, as shown by a hatching area C1, the estimation error of the torque occurs. Therefore, it is thought that the speed change shock caused by the estimation error of the torque occurs. Additionally, it is thought that the completion of the speed change is delayed.

Thus, in the fourth embodiment, even after the dog unit is once synchronized, the ECU 4 continues the correction of the detected torque until the completion of the engagement.

FIG. 15 is a diagram for explaining an effect of the engine torque estimating method according to the fourth embodiment. In FIG. 15, a horizontal axis shows time, and a vertical axis shows an engine torque. Concretely, a graph Te42 shows an example of the predicted torque, and a graph Td42 shows an example of the detected torque. A graph Tr42 shows an example of the actual torque, and a graph Tc42 shows an example of the calculated torque.

The calculated torque Tc42 is calculated based on the correction torque ΔT42 corresponding to the delay time τ42, by the same method as the engine torque estimating method according to the first embodiment. The calculated torque Tc42 is applied until the engagement of the dog unit is completed. Namely, even if the torque gradient calms down to some extent, the correction of the detected torque Td42 is continued until the engagement of the dog unit is completed. Concretely, the calculated torque Tc42 is applied during the time period T42. Therefore, it is possible to prevent the occurrence of the estimation error of the torque as shown by a hatching area C1 in FIG. 14. So, it is possible to improve the engagement performance of the dog unit, and it becomes possible to prevent the delay of the speed change time and the speed change shock.

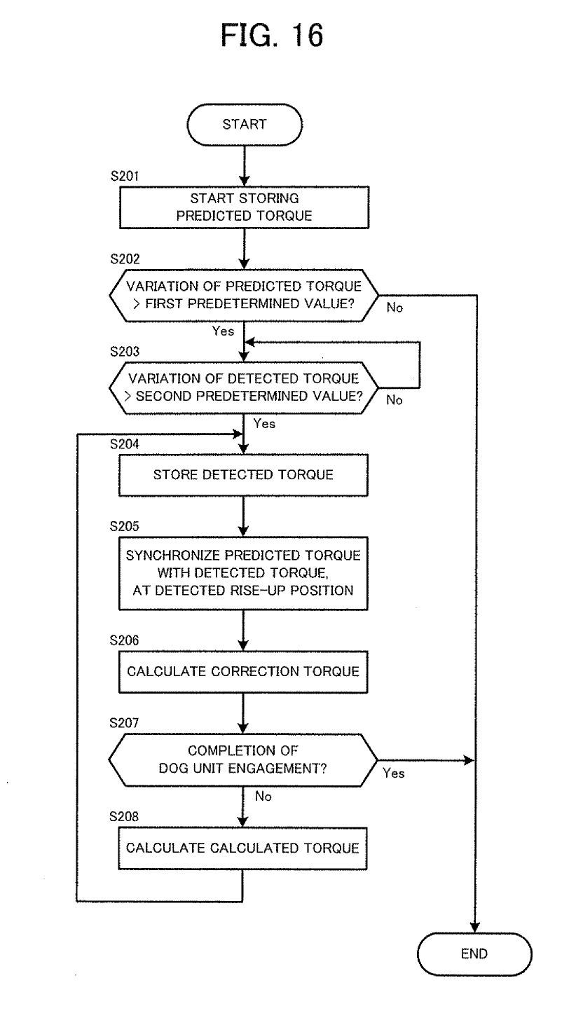

FIG. 16 is a flowchart showing an engine torque estimating process according to the fourth embodiment. The process is repeatedly executed by the ECU 4.

Since processes in steps S201 to S206 and process in step S208 are similar to the processes in steps S101 to S106 and the process in step S108 which are shown in FIG. 7, explanations thereof are omitted. Here, a description will only be given of process in step S207.

In step S207, the ECU 4 determines whether or not the engagement of the dog unit is completed. The process is executed in order to continue the correction of the detected torque until the engagement of the dog unit is completed. When the engagement of the dog unit is completed (step S207; Yes), the process ends. In this case, the correction of the detected torque ends. In contrast, when the engagement of the dog unit is not completed (step S207; No), the process goes to step S208. In this case, the correction of the detected torque is continued.

By the above engine torque estimating method according to the fourth embodiment, since the correction of the detected torque is continued until the engagement of the dog unit is completed, it is possible to improve the engagement performance of the dog unit, and it becomes possible to prevent the delay of the speed change time and the speed change shock.

The fourth embodiment may be performed in combination with the second embodiment and/or the third embodiment. Namely, while the correction of the detected torque is continued until the engagement of the dog unit is completed, the second predetermined value and the filter time constant of the disturbance observer can be changed based on the variation gradient of the predicted torque, and/or the lower limit guard value of the filter time constant of the disturbance observer can be set and the order of the variation gradient of the engine torque which requires the filter time constant below the lower limit guard value can be prohibited.

The above embodiment shows the engine torque estimating method which is performed at the time of the engagement of the dog unit. The estimating method can be similarly performed at the time of the release of the dog unit, too. Namely, the correction of the detected torque is continued until the release of the dog unit is completed.

### Fifth Embodiment

Next, a description will be given of an engine torque estimating method according to a fifth embodiment. In the fifth embodiment, the same method as the engine torque estimating method according to the first embodiment is basically used, too. However, the fifth embodiment is different from the first to fourth embodiments in that the delay time of the detected torque with respect to the predicted torque is learned, and the detected torque is corrected based on the delay time. Concretely, in the fifth embodiment, the ECU 4 learns the delay time of the detected torque with respect to the above synchronized predicted torque, and corrects the detected torque based on the learned delay time during a time period until the rise-up detection of the detected torque, at the time of the next upcoming variation of the torque. This is done in order to estimate the early behavior of the engine torque variation with high accuracy until the predicted torque and the detected torque are synchronized.

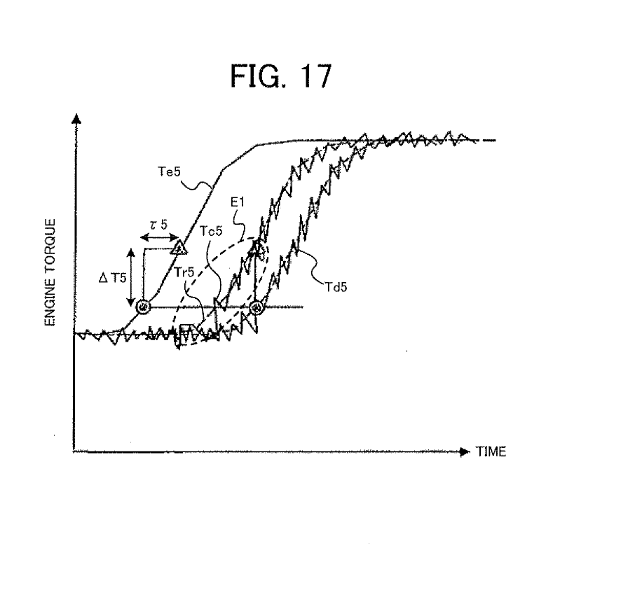

FIG. 17 is a diagram for concretely explaining the engine torque estimating method according to the fifth embodiment. In FIG. 17, a horizontal axis shows time, and a vertical axis shows an engine torque. Concretely, a graph Te5 shows an example of the predicted torque, and a graph Td5 shows an example of the detected torque. A graph Tr5 shows an example of the actual torque, and a graph Tc5 shows an example of the calculated torque.

In the fifth embodiment, in order to appropriately correct the detected torque Td5 during a time period as shown by an area E1 drawn in a broken line in FIG. 17, the ECU 4 corrects the detected torque Td5, based on the learned delay time of the detected torque Td5 with respect to the predicted torque Te5. Therefore, the calculated torque Tc5 is applied during the time period until the rise-up detection of the detected torque Td5.

For example, the ECU 4 stores the delay time in association with the values, such as the oil and water temperatures, the intake air temperature, the number of engine revolutions, the torque and the filter value related to the response of the disturbance observer. This is because the response characteristic of the engine torque is influenced by the operation point (number of revolutions and torque), the direction (increase side and decrease side) of the torque variation, the oil and water temperatures and the intake air temperature, at the time.

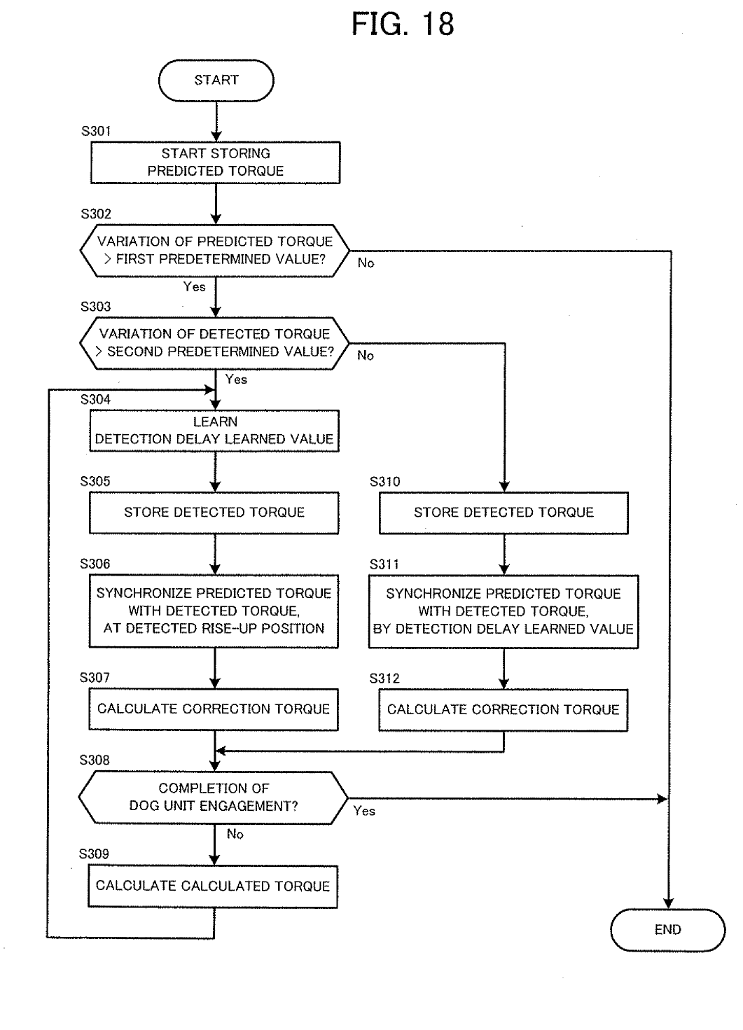

FIG. 18 is a flow chart showing an engine torque estimating process according to the fifth embodiment. The process is repeatedly executed by the ECU 4.

Since processes in steps S301 to S303 and processes in steps S305 to S309 are similar to the processes in steps S201 to S203 and the processes in steps S204 to S208 which are shown in FIG. 16, explanations thereof are omitted. Here, a description will only be given of processes in step S304 and in steps S310 to S312.

When the variation of the detected torque is larger than the second predetermined value (step S303; Yes), the process in step S304 is executed. In step S304, the ECU 4 learns and stores the delay time (i.e., the temporal difference between the predicted torque and the detected torque) of the detected torque with respect to the predicted torque. Concretely, the ECU 4 stores the delay time in association with the values, such as the oil and water temperatures, the intake air temperature, the number of engine revolutions, the torque and the filter value related to the responsiveness of the disturbance observer, which are related to the response of the engine torque. Then, the process goes to step S305.

Meanwhile, when the variation of the detected torque is equal to or smaller than the second predetermined value (step S303; No), the processes in steps S310 to S312 are executed. In step S310, the ECU 4 stores the detected torque used in step S303. Then, the process goes to step S311.

In step S311, the ECU 4 synchronizes the predicted torque with the detected torque, on the basis of the delay time (detection delay learned value) which is preliminary learned and stored in step S304. Then, the process goes to step S312. When the detection delay learned value does not exist due to the noncompletion of the learning, the process in step S311 can be executed by using a predetermined default value. Instead of this, when the detection delay learned value does not exist, the processes in steps S310 to S312 may be omitted.

In step S312, the ECU 4 calculates the correction torque for correcting the detected torque. Concretely, by using the delay time of the estimation by the first estimating method with respect to the actual variation of the engine torque, the ECU 4 calculates the variation amount of the engine torque after the delay time, based on the synchronized predicted torque, and the ECU 4 uses the variation amount of the engine torque as the correction torque. Then, the process goes to step S312.

By the above engine torque estimating method according to the fifth embodiment, it is possible to further improve the detection accuracy of the transient variation of the engine torque. Concretely, even if the direction of the torque variation varies as shown in FIG. 14 and/or the intermittent variation such as the stepped acceleration and deceleration is requested, it is possible to estimate the engine torque with high accuracy.

The above embodiment shows the engine torque estimating method which is performed when the engine torque rises up. The estimating method can be similarly performed when the engine torque falls down, too. Namely, by a similar manner, when the engine torque falls down, the delay time of the detected torque with respect to the predicted torque can be learned, and the detected torque can be corrected based on the delay time, too.

The fifth embodiment may be performed in combination with the second embodiment and/or the third embodiment. Namely, while the detected torque is corrected based on the learned delay time, the second predetermined value and the filter time constant of the disturbance observer can be changed based on the variation gradient of the predicted torque, and/or the lower limit guard value of the filter time constant of the disturbance observer can be set and the order of the variation gradient of the engine torque which requires the filter time constant below the lower limit guard value can be prohibited.

Though the above embodiment shows such an example that the fifth embodiment is performed in combination with the fourth embodiment (see FIG. 15), it is not necessary to perform the fifth embodiment and the fourth embodiment in combination. Namely, it is not necessary to continue the correction of the detected torque until the engagement of the dog unit is completed. However, when the response characteristic of the engine torque substantially differs between the increase side and the decrease side of the torque, it is preferable that the fifth embodiment is performed in combination with the fourth embodiment.

### Sixth Embodiment

Next, a description will be given of an engine torque estimating method according to a sixth embodiment. In the sixth embodiment, the same method as the engine torque estimating method according to the first embodiment is basically used, too. However, the sixth embodiment is different from the first to fifth embodiments in that the predicted torque obtained by the second estimating method is corrected, based on a variation of a state value related to the variation of the engine torque. Concretely, in the sixth embodiment, the ECU 4 corrects the predicted torque in consideration of an influence of the variation of the number of engine revolutions associated with the speed change, and corrects the detected torque by using the corrected predicted torque. The reason is as follows. Since the predicted torque which is used in the above engine torque estimating method is the value based on the number of engine revolutions before the speed change, if the speed change is performed after the prediction, the difference between the predicted torque and the actual torque tends to occur. Therefore, the difference between the obtained calculated torque and the actual torque tends to occur, too.

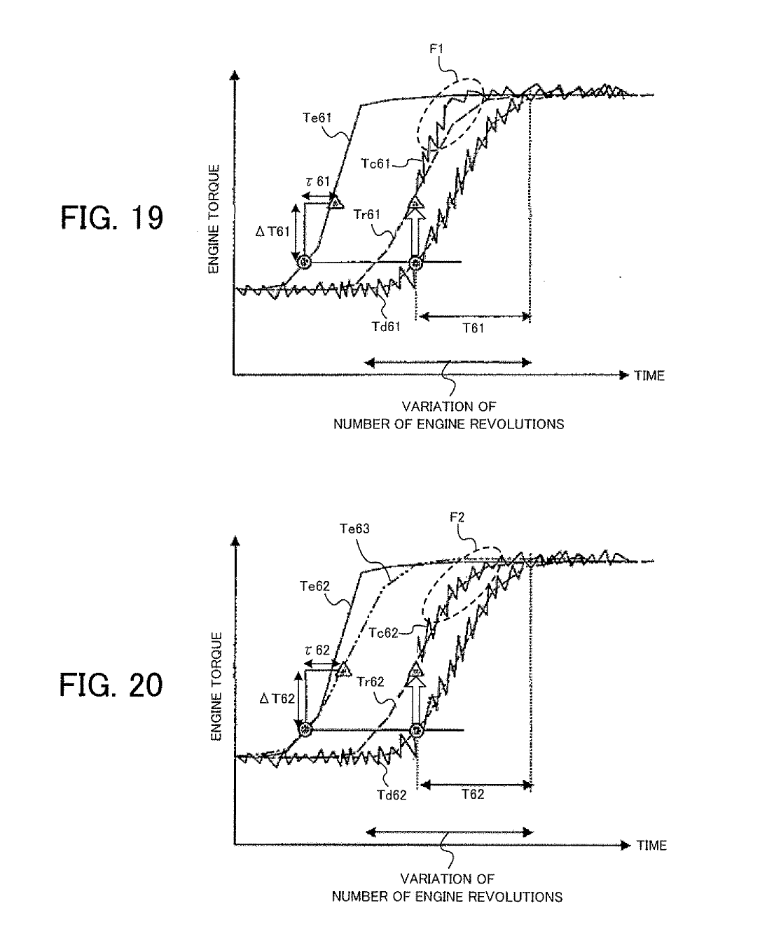

FIG. 19 is a diagram for explaining a problem which occurs in such a case that the predicted torque is different from the actual torque (and the detected torque). In FIG. 19, a horizontal axis shows time, and a vertical axis shows an engine torque. Concretely, a graph Te61 shows an example of the predicted torque, and a graph Td61 shows an example of the detected torque. A graph Tr61 shows an example of the actual torque, and a graph Tc61 shows an example of the calculated torque. The calculated torque Tc61 is calculated based on the correction torque ΔT61 corresponding to the delay time τ61, by the same method as the engine torque estimating method according to the first embodiment. The time period T61 is the applicable period of the calculated torque Tc61.

In this case, since the number of engine revolutions varies as shown by an arrow in FIG. 19, it is assumed that the difference between the predicted torque Te61 and the actual torque Tr61 (and the detected torque Td61) occurs. Concretely, as shown in FIG. 19, it can be understood that the gradient of the predicted torque Te61 is different from the gradient of the actual torque Tr61 and the detected torque Td61. Thereby, as shown by an area F1 drawn in a broken line in FIG. 19, it can be understood that the calculated torque Tc61 calculated based on the predicted torque Te61 departs from the actual torque Tr61.

Therefore, in the sixth embodiment, the ECU 4 corrects the predicted torque in consideration of the influence of the variation of the number of engine revolutions associated with the speed change, and corrects the detected torque by using the corrected predicted torque. Concretely, the ECU 4 adds the correction in consideration of the influence of an actual measured value or a predicted value of the number of engine revolutions associated with the speed change.

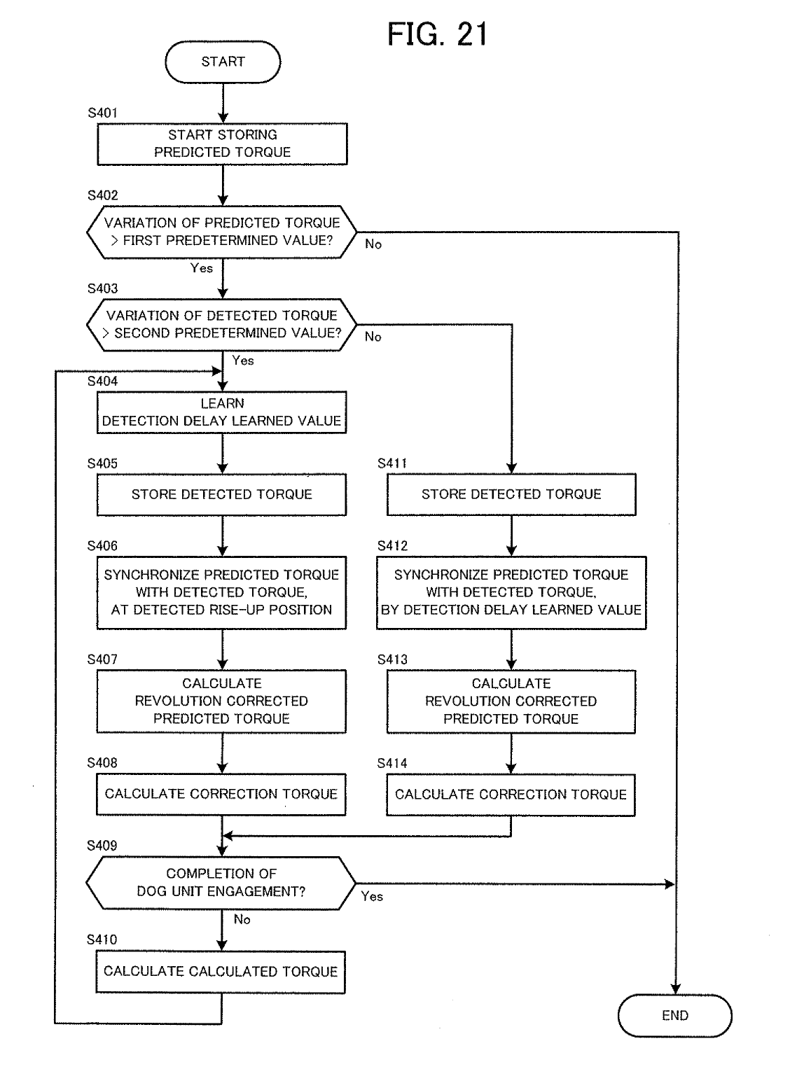

FIG. 20 is a diagram for concretely explaining the engine torque estimating method according to the sixth embodiment. In FIG. 20, a horizontal axis shows time, and a vertical axis shows an engine torque. Concretely, a graph Te62 shows an example of the predicted torque, and a graph Te63 shows an example of the corrected predicted torque. A graph Td62 shows an example of the detected torque. A graph Tr62 shows an example of the actual torque, and a graph Tc62 shows an example of the calculated torque.

In the sixth embodiment, as shown by an arrow in FIG. 20, the ECU 4 corrects the difference of the predicted torque Te62 associated with the variation of the number of engine revolutions. Therefore, as shown by a dashed double-dotted line in FIG. 20, the predicted torque Te63 is calculated. Hereinafter, the corrected predicted torque will be referred to as “revolution corrected predicted torque”. Afterward, by using the revolution corrected predicted torque Te63, the ECU 4 calculates the correction torque ΔT62 corresponding to the delay time τ62. Then, the ECU 4 adds the correction torque ΔT62 to the detected torque Td62, in order to calculate the calculated torque Tc62. As shown by an area F2 drawn in a broken line in FIG. 20, the calculated torque Tc62 approximately coincides with the actual torque Tr62. The time period T62 is the applicable period of the calculated torque Tc62.

FIG. 21 is a flow chart showing an engine torque estimating process according to the sixth embodiment. The process is repeatedly executed by the ECU 4.

Since processes in steps S401 to S406 and processes in steps S409 to S412 are similar to the processes in steps S301 to S306 and the processes in steps S308 to S311 which are shown in FIG. 18, explanations thereof are omitted. Additionally, since processes in steps S413 to S414 are similar to processes in steps S407 to S408, explanations thereof are omitted. Here, a description will only be given of processes in steps S407 to S408.

The processes in steps S407 to S408 are executed after the predicted torque and the detected torque are synchronized. In step S407, the ECU 4 corrects the synchronized predicted torque by using the present information of the number of engine revolutions, in order to calculate the corrected predicted torque (revolution corrected predicted torque). For example, by using a relationship between the filled amount of the intake air of the engine and the number of engine revolutions, the ECU 4 calculates the revolution corrected predicted torque. Then, the process goes to step S408.

In step S408, the ECU 4 calculates the correction torque for correcting the detected torque. Concretely, by using the delay time of the estimation by the first estimating method with respect to the actual variation of the engine torque, the ECU 4 calculates the variation amount of the engine torque after the delay time, based on the revolution corrected predicted torque obtained in step S407, and the ECU 4 uses the variation amount of the engine torque as the correction torque. Then, the process goes to step S409.

By the above engine torque estimating method according to the sixth embodiment, it is possible to further improve the detection accuracy of the transient variation of the engine torque. Concretely, it is possible to effectively improve the estimation accuracy of the engine torque later in the speed change.

The above embodiment shows the engine torque estimating method which is performed when the engine torque rises up. The estimating method can be similarly performed when the engine torque falls down, too. Namely, by a similar manner, when the engine torque falls down, the predicted torque can be corrected based on the variation of the number of engine revolutions, and the detected torque can be corrected by using the corrected predicted torque, too.

The sixth embodiment may be performed in combination with the second embodiment and/or the third embodiment. Namely, while the detected torque can be corrected by using the corrected predicted torque, the second predetermined value and the filter time constant of the disturbance observer can be changed based on the variation gradient of the predicted torque, and/or the lower limit guard value of the filter time constant of the disturbance observer can be set and the order of the variation gradient of the engine torque which requires the filter time constant below the lower limit guard value can be prohibited.

Though the above embodiment shows such an example that the sixth embodiment is performed in combination with the fourth embodiment (see FIG. 21), it is not necessary to perform the sixth embodiment in combination with the fourth embodiment. Namely, it is not necessary to continue the correction of the detected torque until the engagement of the dog unit is completed.

Though the above embodiment shows such an example that the sixth embodiment is performed in combination with the fifth embodiment (see FIG. 21), it is not necessary to perform the sixth embodiment in combination with the fifth embodiment, Namely, it is not necessary to correct the detected torque based on the learned delay time.

The above embodiment shows such an example that the predicted torque is corrected based on the variation of the number of engine revolutions. However, other than the number of engine revolutions, if a state value is related to the variation of the engine torque, the predicted torque may be corrected by using the state value.

(Modification)

The above embodiment shows such an example that the detected torque estimated by the first estimating method is corrected by the predicted torque estimated by the second estimating method. Instead of this, the predicted torque estimated by the second estimating method can be corrected by the detected torque estimated by the first estimating method.

The above embodiment shows the method for estimating the engine torque based on the information of the variation of the number of the first motor generator MG1 revolutions, as the first estimating method. As another example, without using the motor generator, the engine torque can be estimated by using a number of rotations detecting unit, such as a resolver.

The above embodiment shows the method for estimating the engine torque based on the intake air amount of the engine, as the second estimating method. As another example, in such a case that the engine is a diesel engine, the engine torque can be estimated based on fuel injection amount and/or state amount of a turbocharger.

It is not limited that the present invention is applied to the configuration in which the motor generator is connected to either one of the engaging component and the engaged component. The present invention can be applied to a configuration in which the motor generator is connected to both the engaging component and the engaged component.

It is not limited that the present invention is applied to the engagement mechanism (dog brake unit 7) for switching the speed change mode between the infinite variable speed mode and the fixed gear ratio mode. The present invention can also be applied to a mechanism (so-called “MG1 rock mechanism”) which is formed to be able to fix the rotor 11 of the first motor generator MG1. Additionally, it is not limited that the present invention is applied to the engagement mechanism, but the present invention can also be applied to mechanisms, such as a wet type multiplate clutch and a cam clutch.

It is not limited that the present invention is applied at the time of switching the speed change mode between the infinite variable speed mode and the fixed gear ratio mode. Other than this, the present invention can preferably be applied at the time that the engine torque varied.

It is not limited that the present invention is applied to the hybrid vehicle. Additionally, it is not limited that the present invention is applied in case of estimating the engine torque. Other than the engine torque, the present invention can preferably be applied in case of estimating a variation of an object with respect to a time axis. Namely, by using a method for estimating a variation of the object behind an actual variation of the object and a method for estimating a variation of the object before the actual variation of the object, the present invention can estimate the variation other than the variation of the engine torque.

### INDUSTRIAL APPLICABILITY

This invention can be used for a hybrid vehicle.

### DESCRIPTION OF REFERENCE NUMBERS

1 Engine

3 Output Axis

4 ECU

7 Dog Brake Unit

20 Power Distribution Mechanism

31 Inverter

32, 34 Converter

33 HV Battery

MG1 First Motor Generator

MG2 Second Motor Generator

1. An engine torque estimating device, comprising:
a first estimating unit which estimates the engine torque behind an actual variation of the engine torque;
a second estimating unit which estimates the engine torque before the actual variation of the engine torque; and
a correcting unit which performs a correction of one of the first estimating unit and the second estimating unit based on the other, so as to calculate the engine torque, when the engine torque varies.

2. The engine torque estimating device according to claim 1,
wherein the correcting unit calculates a variation amount of the engine torque indicating the variation with a delay time of the estimation by the first estimating unit with respect to the actual variation of the engine torque, by using the second estimating unit, and
wherein the correcting unit adds the calculated variation amount to the engine torque estimated by the first estimating unit, or subtracts the calculated variation amount from the engine torque estimated by the first estimating unit, so as to perform the correction.

3. The engine torque estimating device according to claim 1,
wherein, when the variation of the engine torque estimated by the first estimating unit becomes larger than a predetermined value, the correcting unit performs the correction.

4. The engine torque estimating device according to claim 3,
wherein the correcting unit changes the predetermined value in accordance with a gradient of the variation of the engine torque estimated by the second estimating unit.

5. The engine torque estimating device according to claim 1,
wherein, in order to change a delay time of the estimation by the first estimating unit with respect to the actual variation of the engine torque, the first estimating unit changes a control value for adjusting the delay time, in accordance with a gradient of the variation of the engine torque estimated by the second estimating unit.

6. The engine torque estimating device according to claim 5, further comprising a control unit,
wherein, in case of changing the control value for adjusting the delay time, the first estimating unit sets a lower limit guard value used for the control value, and
wherein the control unit performs a control for restricting the variation of the engine torque so that the control value complies with the lower limit guard value.

7. The engine torque estimating device according to claim 1,
wherein the correcting unit learns a delay time of the estimation by the first estimating unit with respect to the estimation by the second estimating unit, and performs the correction based on the learned delay time.

8. The engine torque estimating device according to claim 7,
wherein, when the variation of the engine torque estimated by the first estimating unit is equal to or smaller than a predetermined value, the correcting unit performs the correction based on the learned delay time.

9. The engine torque estimating device according to claim 1,
wherein the correcting unit corrects the engine torque estimated by the second estimating unit in accordance with a variation of a state value related to the variation of the engine torque, and performs the correction of the first estimating unit based on the corrected engine torque.

10. The engine torque estimating device according to claim 1,
wherein the first estimating unit estimates the engine torque, based on a disturbance observer, and
wherein the second estimating unit estimates the engine torque, based on an intake air amount of the engine.

11. The engine torque estimating device according to claim 1,
wherein the engine torque estimating device is applied to a hybrid vehicle which switches a speed change mode between an infinite variable speed mode and a fixed gear ratio mode by switching between an engagement and a release of engaging components, and
wherein the correcting unit performs the correction, when the speed change mode is switched.

12. The engine torque estimating device according to claim 11,
wherein the correcting unit continues to perform the correction until the engagement of the engaging components is completed.
